(19) United States
(12) Patent Application Publication
(10) Pub. No.: US 2003/0128101 A1
(43) Pub. Date: Jul. 10, 2003

(54) Software for a lock

(76) Inventor: Michael Lee Long, Noblesville, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/287,578

(22) Filed: Nov. 4, 2002

Related U.S. Application Data
(60) Provisional application No. 60/336,037, filed on Nov. 2, 2001.

(51) Int. Cl. H04Q 1/00; G05B 19/00

(52) U.S. Cl. 340/5.26; 340/5.62

(57) ABSTRACT

Software is disclosed for use with a lock and lock key. At least one of the lock and the lock key includes the software that is configured to encrypt information that is compared to a value to determine if the lock is to be opened.

### BACKGROUND OF THE INVENTION

This application claims priority to U.S. Provisional Patent Application No. 60/336,037, to Long, filed Nov. 2, 2001, the disclosure of which is expressly incorporated by reference herein.

This invention relates to locks. More particularly, the present invention relates to software for locks.

According to the present invention, a lock apparatus is provided that is configured to secure a first member to a second member. The lock apparatus includes a lock and a lock key. The lock is configured to move between a locked position blocking movement of the first member relative to the second member from the closed position and an unlocked position permitting the first member to move from the closed position, the lock having an encryption key. The lock and the key are configured to communicate information therebetween. The lock key has the encryption key. The lock is configured to encrypt the information into a first value. The lock key is configured to encrypt the information into a second value. At least one of the lock key and the lock are configured to compare the first and second values to determine if the lock key is authorized to move the lock from the locked position.

According to another aspect of the present invention, a vending machine system is provided that is configured to retain objects for distribution. The vending machine system includes a plurality of vending machines and a key. Each vending machine includes a cabinet defining an interior region sized to receive the objects for distribution, a door coupled to the cabinet to move between an opened position permitting access to the interior region of the cabinet and a closed position blocking access to the interior region of the cabinet, and a lock configured move between a locked position blocking movement of the door from the closed position and an unlocked position permitting the door to move from the closed position. Each lock of the plurality of vending machines has an access code. The key is configured to store the plurality of access codes of the locks of the plurality of vending machines to permit access to the plurality of vending machines.

According to another aspect of the present invention, a method for unlocking a lock is provided. The method includes the steps of providing a lock having an encryption key and a lock key having the encryption key, encrypting information with the lock using the encryption key to generate a first value, encrypting information with the lock key using the encryption key to generate a second value, and comparing the first value with the second value to determine if the lock should be opened.

Additional features of the present invention will become apparent to those skilled in the art upon consideration of the following detailed description of an illustrated embodiment exemplifying the best mode of carrying out the invention as presently perceived.

### BRIEF DESCRIPTION OF THE DRAWINGS

A detailed description particularly refers to the accompanying figures in which:

FIG. 1 is a diagrammatic view of a vending machine and a token showing the vending machine including a cabinet, a door, and a lock configured to lock the door to the cabinet and the token positioned to communicate with the lock;

FIG. 2 is a diagrammatic view of the lock of FIG. 1 showing the lock including first and second lock members configured to lock the door to the cabinet, a lock member control configured to control movement of the first lock member from a locked position, a controller, and a communications device configured to communicate with the token; and

FIG. 3 is a flow diagram showing steps in an authentication process for determining whether a user and the token should be permitted to open the vending machine or communicate with the vending machine.

### DETAILED DESCRIPTION OF THE DRAWINGS

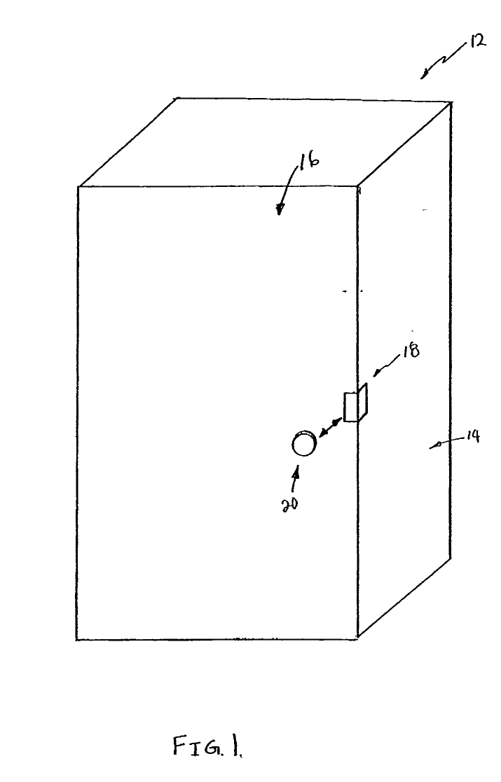

As shown in FIG. 1, a vending machine 12 is provided for storing and dispensing objects, such as cans or bottles of beverages, food stuff items, magazines, or other objects. Vending machine 12 includes a cabinet 14 having an interior region for storing the objects and a door 16 permitting access to the interior region of the cabinet 14 for restocking, maintenance, or for any other reason for which access to the interior region may be necessary.

To prevent unauthorized access to the interior region, a lock 18 is provided that locks door 16 to cabinet 14. As illustrated throughout, lock 18 is described in use with vending machine 12. According to alternative embodiments of the present disclosure, the lock is used in other applications where limited access is necessary or desirable. For example, according to one embodiment, the lock is provided for a door to a room or building. According to another embodiment, the lock is provided on an ATM (Automatic Teller Machine). According to yet another embodiment, the lock is provided for a vehicle. Thus, according to the present disclosure, the lock can be provided in any application requiring electrically controlled or other types of locks.

According to the present disclosure, a token 20 is provided for unlocking lock 18 to permit access to the interior region of cabinet 14 and/or for communicating information to and from vending machine 12. According to the present disclosure, token 20 may be any of a number of communications devices, such as keypads, electronic key fobs, key cards, keys, PDA's (personal digital assistants) or any other electronic or other device, that is configured to permit access to vending machine 12.

Token 20 is programmed to provide access to a plurality of specific vending machines 12 and to deny access to other vending machines 12. For example, a specific token 20 is provided to a specific user, such as vending machine stocker that has an assigned route. The specific token 20 is programmed to include information specific to those vending machines 12 located on his assigned route. Thus, the specific token 20 given to the vending machine stocker will open only those vending machines 12 on his assigned route and will not open other vending machines 12 not on his assigned route.

According to an alternative embodiment of the present disclosure, the token is programmed to open only a specific lock. For example, when used with in a vehicle application, the token is programmed to open the lock to a specific car.

An owner of a vending machine stocking company may own multiple tokens 20 that are programmed for specific routes. Each stocker is given a token 20 for their specific route and proceeds with restocking vending machines 12 on his route using the specific token 20 programmed to open those vending machines. After the route is complete, the vending machine stocker returns his token 20. The specific token 20 can be reprogrammed for the next route or another token 20 programmed for a that route is given to the vending machine stocker to use during his next assigned route.

Preferably, tokens 20 can also be updated so that access right to specific vending machines 12 can be added and removed as needed. For example, token 20 can be updated to add access rights for a new vending machine 12 on a route or reprogrammed for access rights to an entirely different route. Thus, access to specific vending machines 12 on a route can be changed at a central location without having to visit the specific vending machines 12 on the route. According to an alternative embodiment of the present disclosure, the token is not programmable, but has a fixed configuration.

Tokens 20 are programmed to contain information specific to vending machines 12. This information permits token 20 to gain access to those specific vending machines 12. Thus, if a token 20 is presented to vending machine 12 without this information, vending machine 12 will deny access. Furthermore, if the information specific to a particular vending machine 12 on a route is changed, the specific token 20 for that route can be updated with the new vending machine information.

Tokens 20 are also configured to communicate with a central computer or other device to download information stored in token 20. Thus, information recorded from interaction with the various vending machines 12 or information received from the various vending machines 12 themselves can be collected, analyzed, and distributed.

To open door 16 of vending machine 12 or to communicate with vending machine 12, a user, such as the assigned vending machine stocker or maintenance worker, presents token 20 to vending machine 12. Token 20 requests that lock 18 is opened or that communication is opened with vending machine 12. Token 20 is configured to verify that the user has the required privileges for accessing the interior region of cabinet 14 and/or for communicating with vending machine 12. Token 20 is also configured to do a self-verification to determine if it has access/communication rights to the particular vending machine 12. Furthermore, lock 18 is also configured to verify that token 20 has access/communication rights.

If the user and token 20 are authorized to access vending machine 12, then lock 18 moves to the unlocked position permitting door 16 to be opened. If the user and token 20 are authorized to communicate with vending machine 12, then vending machine 12 permits such communication. According to the present disclosure, some tokens only have access rights and other tokens only have communication rights.

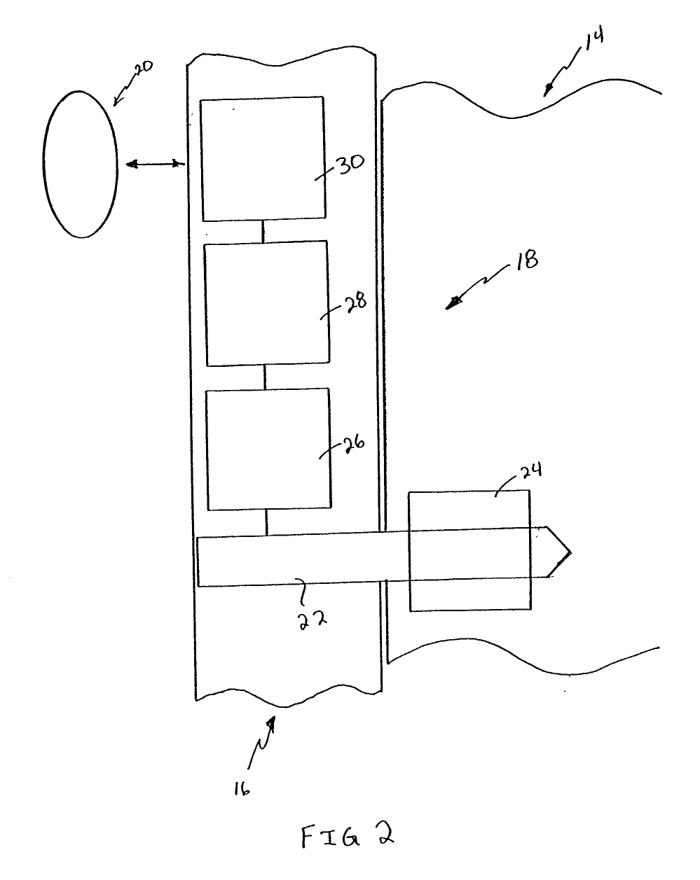

As shown in FIG. 2, lock 18 includes a first lock member 22 coupled to door 16, a second lock member 24 coupled to cabinet 14, a lock member control 26 coupled to first lock member 22, a controller 28 coupled to lock member control 26, and communication device 30 coupled to controller 28. First and second lock members 22, 24 interact with each other to lock door 16 to cabinet 14. When first and second lock members 22, 24 are coupled together, door 16 is blocked from moving relative to cabinet 14 so that the interior region of cabinet 14 is inaccessible.

To open door 16, first and second lock members 22, 24 must be uncoupled. First and second lock members 22, 24 are uncoupled by separating or moving first lock member 22 from second lock member 24. According to the preferred embodiment of the present disclosure, first lock member 22 is moved relative to door 16 and second lock member 24 to unlock door 16. According to an alternative embodiment of the present disclosure, the second lock member is moved relative to the cabinet and the first lock member to unlock the door.

Lock member control 26 is configured to control the movement of first lock member 22. When lock member control 26 is activated, first lock member 22 is permitted to move or is moved by lock member control 26. For example, according to a first embodiment of the present disclosure, lock member control 26 blocks movement of first lock member 22 unless it is activated. According to a second embodiment, lock member control 26 moves first lock member 22 when activated. According to other alternative embodiments, other configurations of lock member controls are provided that control the movement of first lock member 22.

According to the first embodiment of the present disclosure, lock member control 26 is a secondary latch that must be moved to an unlocked position before first lock member 22 can be moved. Once lock member control/secondary latch 26 is moved/activated, the user can manually or otherwise move first lock member 22 relative to second lock member 24 to unlock door 16. Additional description of such a secondary latch is provided in U.S. Provisional Patent Application Serial No. 60/276,546, titled Electro-Mechanical Vending Machine Lock, to Palmer, filed Oct. 17, 2001. The disclosure of which is expressly incorporated by reference herein.

According to the second embodiment of the present disclosure, lock member control 26 is an electric motor that rotates first lock member 22, a threaded rod, relative to second lock member 24, a threaded nut. When lock member control/electric motor 26 is powered/activated, lock member control/electric motor 26 rotates the threaded rod/first lock member 22 relative to the threaded nut/second lock member 24 to unlock door 16. Additional description of several such electric motor arrangements is provided in U.S. Provisional Patent Application Serial No. 60/276,546, entitled “Lock,” filed on Mar. 16, 2001 to Beylotte et al.; U.S. Patent Provisional Application Serial No. 60/245,352, entitled “Lock,” filed Nov. 2, 2000, to Beylotte et al.; and U.S. patent application Ser. No. 10/000,203, to Beylotte et al., entitled “Vending Machine Lock,” filed Nov. 2, 2001, the disclosures of which are expressly incorporated by reference herein.

Controller 28 is configured to determine when an authorized user and token 20 are presented to vending machine 12. If controller 28 determines that the user is authorized to access vending machine 12 and token 20 is valid for that particular vending machine 12, it will activate lock member control 26 to permit movement of and/or move first lock member 22 and unlock door 16. Similarly, if controller 28 determines that the user and token 20 are valid, it will permit communication between vending machine 12 and token 20.

According to the preferred embodiment of the present disclosure, token 20 transmits information to communication device 30. Communication device 30 transmits the information to controller 28 that then determines whether to permit access to vending machine 12. Preferably, token 20 uses “wire-less” communication, such as RF (radio frequency) or IR (infrared) signals, to transmit information to and receive information from communication device 30. According to alternative embodiments of the present disclosure, “wired” or other direct communications are used to provide the communication between the token and communication device.

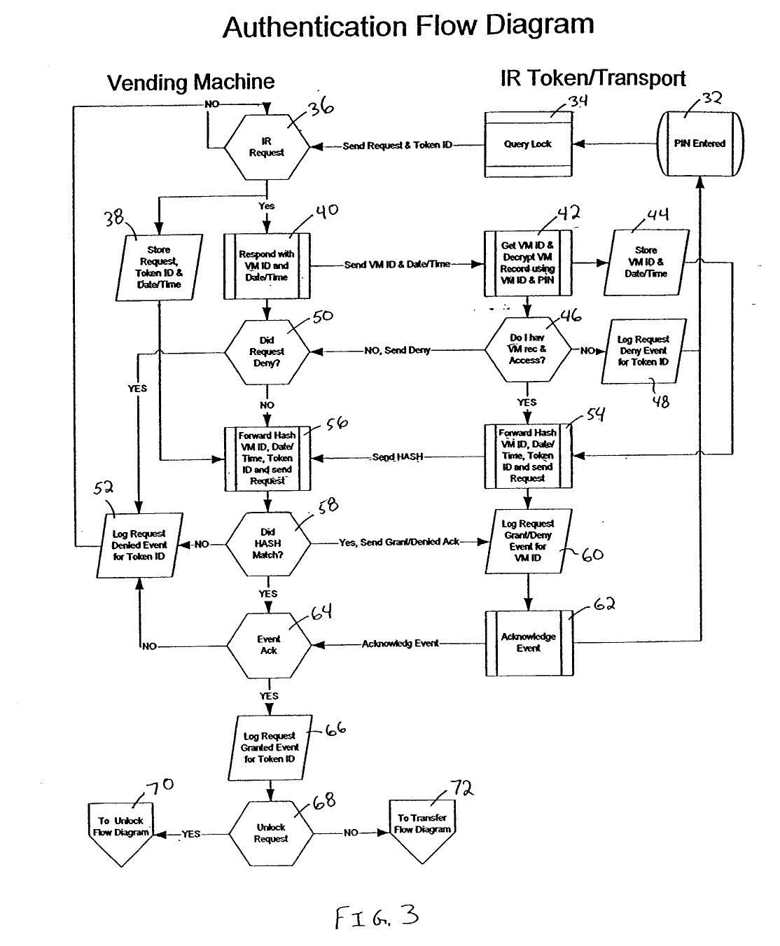

For a user to be consider authorized, they must know a code specifically assigned to the specific token 20. If the user of token 20 does not known the specific code, access to vending machine 12 will be denied. As shown in FIG. 3, to begin the access process, a user must enter a user assigned code/Personal Identification Number (PIN) into token 20 during a PIN-entering step 32. Preferably, token 20 has a keypad (not shown) or other data entry device for entering the PIN. According to an alternative embodiment of the present disclosure, no PIN is required.

Once the PIN is entered, token 20 queries lock 18 of vending machine 12 during a query lock step 34. During query lock step 34, token 20 sends a request to vending machine 12. The request includes information including a Send Request Code indicating the type of request (to open lock 18 and/or communicate with vending machine 12) and an identification code (Token ID) specific to token 20. During a polling step 36, lock 18 polls for the Send Request Code and Token ID. Communication device 30 is configured to receive the Send Request Code, Token ID, and other data sent from token 20 and to communicate the information to controller 28.

If no Send Request Code and Token ID are received during polling step 36, communication device 30 continues polling and repeats polling step 36. If a Send Request Code and Token ID are received, controller 28 creates a Date/Time Stamp (or other variable data as discussed below) and stores it along with the Send Request Code and Token ID in memory in a storage step 38. Preferably, the Date/Time Stamp includes the year, month, day, hour, and second.

During a response step 40, controller 28 responds to query lock step 34 by sending information through communication device 30 to token 20. This information includes an identification code (VM ID) specific to vending machine 12 and the Date/Time Stamp indicating the time and date that the request was received. Because of these communications, both token 20 and controller 28 of vending machine 12 know the Send Request Code, Token ID, VM ID, and Date/Time Stamp.

Token 20 receives the VM ID and Date/Time Stamp from communication device 30 during a data decryption step 42. During data decryption step 42, token 20 uses the VM ID and PIN in an attempted to decrypt information relating to the specific vending machine 12. The encrypted information was previously encrypted and stored in token 20 during the initial programming of token 20 for the particular stocking route.

After data decryption step 42, token 20 stores the VM ID and Date/Time Stamp in a storage step 44 and determines whether access should be granted based on the VM ID and PIN during an access determination step 46. If the PIN is incorrect for token 20 or token 20 was not previously programmed to access this particular vending machine 12, token 20 will not be able to decrypt the necessary information.

If token 20 was unable to decrypt the necessary information, access to vending machine 12 is denied during access determination step 46. Because token 20 was unable to decrypt the necessary information, it knows that the user is not authorized to access vending machine 12. By requiring a PIN, an unauthorized user who does not know the correct PIN is blocked from accessing vending machine 12 even if token 20 is authorized to access the specific vending machine 12.

If token 20 is not programmed to open this specific vending machine 12, it will also deny access to vending machine 12 during access determination step 46. For example, if the VM ID received from vending machine 12 does not match one of the VM ID's stored in token 20, token 20 will not be able to decrypt the information stored in token 20. Because it was unable to decrypt the stored information, it knows that it is unauthorized to access vending machine 12 and access is denied.

According to an alternative embodiment of the present disclosure, the decrypting step is not provided. Thus, the VM ID and PIN are not required to acquire the information specific to the particular vending machine. During the access determination step, the token checks if the particular VM ID matches the list of vending machines it is programmed to access. If the particular vending machine is not on the list, the token denies access.

By matching the VM ID with the VM ID'S stored in token 20, not every token 20 will be able to access every vending machine 12. Thus, a specific token 20 will only be authorized to open specific vending machines 20. Thus, even though an unauthorized user may known the correct PIN for a token 20, token 20 will deny access to this specific vending machine 12 if it does not have access rights.

If access is denied because of an incorrect PIN or lack of access rights, token 20 sends a denial signal to vending machine 12. Thus, if token 20 detects that the user or itself is unauthorized, it notifies vending machine 12 to deny such access. Token 20 also logs the request denial in a denial logging step 48 and returns to PIN-entering step 32 and waits for the next PIN to be entered.

As previously mentioned, if token 20 denies access, it sends a signal to vending machine 12. After response step 40, controller 28 waits for the denial signal during a denial determination step 50. If controller 28 receives a denial from token 20, it logs the denial along with the Token ID in a denial logging step 52. After the denial is logged, controller 28 returns to polling step 36 and waits for the next request from a token 20.

If token 20 is authorized to open this specific vending machine 12 and the correct PIN was entered, token 20 will decrypt the information stored therein during decryption step 42 as described above. Included in the decrypted information is an encryption key unique to the specific vending machine 12.

Token 20 uses the encryption key to create a forward hash based on the stored VM ID, Date/Time Stamp, Send Request Code, and Token ID during an encryption step 54. Token 20 then sends the forward hash to vending machine 12.

If controller 28 of vending machine 12 fails to receive a denial of access signal from token 20, it uses its unique encryption key stored in its memory to create a forward hash based on the stored Send Request Code, Token ID, Date/Time Stamp, and VM ID during its own encryption step 56. Because token 20 and controller 28 have used the same encryption key specific to vending machine 12 based on the same information (i.e. the Send Request Code, Token ID, VM ID, and Date/Time Stamp), the forwarded hashes generated by each will match.

According to the preferred embodiment of the present disclosure, vending machine 12 and token 20 use the RSA MD5 hash technique to the create the forward hashes. According to alternative embodiments of the present disclosure, other hash techniques known to those of ordinary skill in the art are used. For example, according to some embodiments, the RSA MD2 and RSA MD4 hash techniques are used.

During a comparison step 58, controller 28 compares the forwarded hashes generated by token 20 and vending machine 12. If the hashes do not match, controller 28 proceeds to denial logging step 52. During the comparison step 58, controller 28 sends a grant or denial acknowledgement to token 20 that logs the grant or denial in a logging step 60. Token 20 acknowledges the grant or denial of the request in an acknowledge event step 62 and reports the acknowledgement back to controller 28. After reporting the event acknowledgement, token 20 returns to PIN-entering step 32 and waits for the next PIN to be entered.

If the hashes do match, controller 28 moves to an event acknowledgement polling step 64 and waits for token 20 to acknowledge the grant or denial during acknowledge event step 62. If controller 28 fails to receive the event acknowledgement, controller 28 proceeds to denial logging step 52. If the acknowledge event is received, controller 28 proceeds to a grant logging step 66 where the grant event and Token ID are logged in memory.

Next, controller 28 proceeds to a request determination step 68 to determine whether access to the interior region of cabinet 14 was requested or whether communication with vending machine 12 was requested. If access to the interior region was requested, controller 28 proceeds to an unlocking step 70 and activates lock member control 26 to permit movement of first lock member 22 from the locked position (for the first embodiment lock member control 26 described above) or to move first lock member from the locked position (for the second embodiment lock member control 26 described above). After door 16 is unlocked, controller 28 returns to polling step 36 and waits for the next Send Request Code and Token ID.

If controller 28 determines that communications was requested during request determination step 68, vending machine 12 will communicate information with token 20 during a data transfer step 72. Such information may include the grant and denial information previously stored. Thus, by communicating with vending machine 12, a user can download when access requests were made, what type of requests were made, whether the requests were successful or not, and the Token ID's associated with the respective requests. After permitting communication, controller 28 returns to polling step 36 and waits for the next Send Request Code and Token ID.

After a stocker completes a route, data from his respective token 20 is downloaded into the central computer. This information is used to perform an audit of the specific token's use. The information is stored, analyzed, and communicated. If any abnormalities are detected, they can be investigated. For example, if a vending machine 12 denies access to a valid token 20 and user, the specific vending machine 12 and token 20 can be reviewed to determine why access was denied. Furthermore, if a stocker is attempting to access vending machines 12 that they do not have access to, further investigation can be made.

This information retrieved by token 20 is used to perform an audit of the specific vending machine 12 to monitor attempts at accessing vending machine 12. For example, if an attempt to open vending machine 12 was made by an unauthorized token 20, an investigation can be made to determine why the unauthorized token 20 was being used to gain access to vending machine 12 or to communicate with vending machine 12. Similarly, if an attempt to open a machine 12 was made using an unauthorized, but stolen token 20 by an unauthorized person who entered an incorrect PIN, the encryption key to vending machine 12 can be changed. Because the encryption key to the vending machine 12 was changed, the stolen token 20 will not know the new encryption key. Because token 20 does not know the new encryption key, the forward hashes generated during the verification process will not match and controller 28 will deny access.

According to an alternative embodiment of the present disclosure, the token has an expiration date that prevents use of the token past a certain time. Such a token becomes dysfunctional after a certain amount of time. Thus, if the token is stolen, lost, or not returned, and an unauthorized person knows or guesses the correct PIN, if required, the token will not work after the expiration date. According to one embodiment, the token is configured to expire after a 12 hour period to give a vending machine stocker enough time to complete a route, but little or any time for an unauthorized person to access many, if any, vending machines. According to other alternative embodiments, other expiration periods are provided, such as one day, a week, or any other suitable time spans. When a token is given to a stocker or other authorized person, the expiration period is restarted.

Several expiration techniques are provided. According to one embodiment, a expiration checking step is provided. The token verifies it's expiration status and refuses to start or continue the verification/entry process if the token has expired. According to another embodiment, the token's memory erases or makes unavailable the encryption keys to create the forward has. According other embodiments, other expiration techniques known to those of ordinary skill in the art are provided.

The verification process is configured to prevent access to vending machine 12 even if an interceptor records the Send Request Code, Token ID, VM ID, Date/Time, and forward hash sent between token 20 and vending machine 12. Because the encryption key of the specific vending machine 12 is never communicated between vending machine 12 and token 20, the interceptor will not have the encryption key for the specific vending machine 12. Without the proper encryption key, the interceptor will be unable to create a matching forward hash that matches the forward hash generated by vending machine 12 even though the interceptor may know the Send Request Code, Token ID, VM ID, and Date/Time Stamp. Because the forward hashes will not match, controller 28 will deny access to vending machine 12.

Even if the interceptor records the transmitted forward hash, they will still be unable to gain access to vending machine 12. Unless the interceptor attempts to gain access to the interior region of vending machine 12 while it is still open, the interceptor must wait until the stocker closes door 16 and leaves. If the interceptor is successful in initiating the verification process by providing the intercepted Token ID, controller 28 will send out the VM ID and a new Date/Time Stamp and wait for a denial. If no denial is received, vending machine 12 will generate a new forward hash based on the new Date/Time Stamp, VM ID, Token ID, and Send Request Code.

Because time has passed, the new Date/Time Stamp sent to the interceptor by controller 28 will be different that the old Date/Time Stamp sent earlier to the authorized user and recorded by the inceptor. As previously mentioned, because the encryption key was never communicated, the interceptor cannot create a forward hash based on the new Date/Time Stamp, but must send the intercepted forward hash based on the old Date/Time Stamp. Because the intercepted forward hash sent by the interceptor and the new forward hash generated by controller 28 are based on different Date/Time Stamps, they will not match. Thus, when controller 28 compares the forward hashes during comparison step 58, it will recognize that they do not match and access will be denied. Controller 28 will log a denial and the Token ID. Controller 28 then returns to polling step 36. During a later audit, this unauthorized attempt at accessing vending machine 12 can be analyzed.

According to alternative embodiments of the present disclosure, variable data other than a Date/Time Stamp is used during the authentication process. For example, according to one embodiment of the present disclosure, a counter is used. According to other embodiments, random number generators, check-sums, and/or data packets are used.

According to another alternative embodiment of the present disclosure, the token sends the variable data. According to yet another embodiment, each of the controller and token send variable data to each other. The forward hashes are then based on the variable data sent by each of the controller and token. Thus, an interceptor must know both sets of variable data to gain access.

According to yet another embodiment of the present disclosure, a second forward hash is generated by both the controller and the token. The second forward hash is based on the first forward hash and the second variable data sent from the token to the vending machine. The second forward hashes are compared and access is denied by the controller if the second forward hashes do not match.

After access is granted or denied, controller 28 goes into a “sleep” mode during polling step 36 and shuts down to conserve energy stored in the battery (not shown) that powers controller 28. Communication device 30 continues polling for the next Send Request Code and Token ID. When communication device 30 receives the next Send Request Code and Token ID, controller 28 wakes up to process the access request.

During denial request step 52, controller 28 waits for a predetermined delay time before controller 28 returns to polling step 36. According to the present disclosure, the delay time is 1 second. By incorporating a delay into the authentication procedure, each attempt to access vending machine 12 will take at least 1 seconds. Thus, if an unauthorized person attempts to access vending machine 12 by using random PIN's or encryption keys, the amount of time necessary to happen upon the correct PIN or encryption key would be prohibitively long because of the large number of possible PIN's and encryption keys.

Although the present invention has been described in detail with reference to preferred embodiments, variations and modifications exist within the scope and spirit of the present invention as described and defined in the following claims.

1. A lock apparatus configured to secure a first member to a second member, the lock apparatus comprising
a lock configured to move between a locked position blocking movement of the first member relative to the second member from the closed position and an unlocked position permitting the first member to move from the closed position, the lock having an encryption key, and
a lock key, the lock and the lock key being configured to communicate information therebetween, the lock key having the encryption key, the lock being configured to encrypt the information into a first value, the lock key being configured to encrypt the information into a second value, at least one of the lock key and the lock being configured to compare the first and second values to determine if the lock key is authorized to move the lock from the locked position.

2. The lock apparatus of claim 1, wherein the lock has an identification code that is included in the information that is communicated and encrypted.

3. The lock apparatus of claim 1, wherein at least one of the lock and lock key is configured to generate variable data that is included in the information communicated and encrypted.

4. The lock apparatus of claim 1, wherein the lock key and lock generate a forward hash using the encryption key and communicated information.

5. The lock apparatus of claim 1, wherein the lock key has an identification code and the lock is configured to store the identification code.

6. The lock apparatus of claim 1, wherein the lock has an identification code and the lock key includes a table of accessible lock identification codes, the lock key is configured to receive the identification code of the lock and verify whether the identification code of the lock is in the table of accessible lock identification codes.

7. The lock apparatus of claim 1, wherein the lock and the lock key communicate using wireless communication.

8. A vending machine system configured to retain objects for distribution, the vending machine system comprising
a plurality of vending machines, each vending machine including a cabinet defining an interior region sized to receive the objects for distribution, a door coupled to the cabinet to move between an opened position permitting access to the interior region of the cabinet and a closed position blocking access to the interior region of the cabinet, and a lock configured move between a locked position blocking movement of the door from the closed position and an unlocked position permitting the door to move from the closed position, each lock of the plurality of vending machines having an access code, and
a lock key configured to store the plurality of access codes of the locks of the plurality of vending machines to permit access to the plurality of vending machines.

9. The vending machine system of claim 8, wherein the lock key and at least one of the locks includes an encryption key, the lock key and said lock are configured to encrypt information based on the encryption key to generated values, at least one of said lock key and the locks is configured to compare the generated values to permit said lock to move to the opened position.

10. The vending machine system of claim 8, wherein the vending machines are configured to communicate the access codes to the lock key and the lock key is configured to record the communicated access codes.

11. The vending machine system of claim 10, wherein the lock key is configured to communicate the communicated access codes to a central station.

12. A method for unlocking a lock, the method comprising the steps of
providing a lock having an encryption key and a lock key having the encryption key,
encrypting information with the lock using the encryption key to generate a first value,
encrypting information with the lock key using the encryption key to generate a second value, and
comparing the first value with the second value to determine if the lock should be opened.

13. The method of claim 12, wherein at least one of the lock and the lock key is configured to generate variable data which is encrypted in the encrypting steps to generate the first and second values.

14. The method of claim 12, wherein the lock includes an identification code and the lock key includes a table of identification codes, further comprising the step of comparing the identification code of the lock with the table of identifications codes to determine if the lock key has access rights to the lock.

15. The method of claim 12, wherein the lock has an identification code and the lock key has an identification code.

16. The method of claim 15, wherein the identification code of the lock is communicated to the lock key.

17. The method of claim 15, wherein the identification code of the lock key is communicated to the lock.

18. The method of claim 15, wherein the identification code of the lock is included in the information encrypted during the encryption steps.

19. The method of claim 15, wherein the identification code of the lock key is included in the information encrypted during the encryption steps.

20. The method of claim 12, wherein at least one of the lock and the lock key communicates the information that is encrypted during the encryption steps.
